(19) United States
(12) Patent Application Publication
(10) Pub. No.: US 2020/0331078 A1
(43) Pub. Date: Oct. 22, 2020

(54) Method for Machining Titanium Alloys Using Polycrystalline Diamond

(71) Applicant: Makino Inc., Mason, OH (US)

(72) Inventors: David Olvera, Washington Township, OH (US); Mark W. Larson, Hamilton, OH (US); Brian T. List, Loveland, OH (US); Paul L. Meredith, Cincinnati, OH (US)

(21) Appl. No.: 16/850,482

(22) Filed: Apr. 16, 2020

Related U.S. Application Data
(60) Provisional application No. 62/835,862, filed on Apr. 18, 2019.

(51) Int. Cl. B23C 5/20; B23C 3/13

(52) U.S. Cl. CPC B23C 5/207; B23C 2200/0455; B23C 3/13

(57) ABSTRACT

The subject invention is directed to metal working operations and, more particularly, to machining heat resistant super alloys (HRSAs) such as titanium alloys with polycrystalline diamond cutting inserts sintered on a carbide substrate. Using at least one cutting insert mounted upon a rotary toolholder and wherein the at least one cutting insert has a substrate with a top layer of PCD secured thereto over no less than 1/3 of a substrate top surface, a method of machining heat resistant super alloys (HRSAs) is made up of the steps of rotating the rotary toolholder such that an insert surface speed rate is above 50 meters per minute and adjusting a tool feed rate (advance per tooth per revolution) and/or radial engagement of the toolholder such that the machining operation produces chips having a thickness of approximately 0.050-0.200 millimeters.

### CROSS REFERENCE TO RELATED APPLICATIONS

This application claims the benefit of U.S. Provisional Application No. 62/835,862 filed Apr. 18, 2019 and hereby incorporates by reference in its entirety the contents of that application. This application incorporates by reference in its entirety the contents of United States Patent Publication No. 2020/0001374.

### BACKGROUND OF THE INVENTION

### Field of the Invention

The subject invention is directed to metal working operations and, more particularly, to machining heat resistant super alloys (HRSAs) such as titanium alloys with polycrystalline diamond cutting inserts sintered on a carbide substrate with Polycrystalline diamond (PCD) thickness greater than 1 millimeter.

### Description of Related Art

PCD has been used for years in metal working operations and, in particular, in machining aluminum parts. However, the PCD material is very expensive and does not last long when cutting ferrous materials or titanium alloys. PCD tips are traditionally “brazed” onto a carbide substrate, because of the high cost of PCD material, inserts use very small amounts of PCD (for example, a small triangle on one corner). While these brazed tips are very effective with certain metal working operations, under certain other conditions, such as machining titanium alloys, the braze between the PCD inserts and the carbide substrate becomes weak from high temperatures and is prone to failure.

Overall, cutting metal generates heat and all materials transfer heat at different rates. The measurement of this rate is called the coefficient of thermal conductivity. PCD transfers heat at a rate around 800 W/m-K, but tungsten carbide, on the other hand, transfers heat at 28 W/m-K. The low transfer rate of carbide is good in most cases because it resists the heat. The work piece or, furthermore, the cut chips removed from the work piece absorb the heat if the work piece heat transfer rate is higher. When machining work pieces made of heat resistant super alloys, the cutting operation transfers heat rapidly through the PCD tip and to the substrate supporting the tip. In previous designs with the PCD tip brazed in a substrate, the heat absorbed by the cutting tool softens and weakens the braze and the tool fails. Furthermore, at higher speeds using carbide cutting inserts, more frictional heat is generated increasing the temperatures and softening the carbide tool leading to early failure.

Currently, the function of machining titanium alloys is accomplished by high-speed steel cutters or carbide cutters (either solid or inserted) but not by PCD based tool materials for reasons just discussed, and further, due to the fragility and cost of the PCD material.

A need exists for machining heat resistant super alloys such as titanium with PCD inserts. Also, an arrangement and method are needed and adapted not only to machine titanium alloys with PCD inserts, but to machine titanium alloys or other HRSA materials with a high-speed application having surface speeds that may exceed 50 meters per minute.

### SUMMARY OF THE INVENTION

Using at least one cutting insert mounted upon a rotary tool holder, wherein at least one cutting insert is comprised of a substrate having a top layer of PCD at least of 1 millimeter thickness secured or integral with the substrate top surface, a method of machining HRSAs comprising the steps of rotating the rotary tool holder such that the insert surface speed rate is above 50 meters per minute; and adjusting the tool feed rate (advance per tooth per revolution) and/or the radial engagement of the tool holder such that the machining operation produces chips having a thickness of approximately 0.050-0.200 millimeters.

### BRIEF DESCRIPTION OF THE DRAWING(S)

FIG. 1A illustrates an isometric view of a cutting insert with a PCD layer on top of a substrate;

FIG. 1B illustrates a top view of the cutting insert in FIG. 1A with a PCD layer on top of a substrate;

FIGS. 1C-1E illustrate a side perspective view, a top view, and a front perspective view of another embodiment of a cutting insert with a PCD layer on top of a substrate;

FIGS. 2A-2C illustrate typical tool holders that may be utilized for machining using the PCD inserts;

FIG. 3 is a chart illustrating cutting speed and life for different cutting insert materials;

FIGS. 4A and 4B illustrate potential tool paths the tool may follow during a pocketing operation;

FIGS. 5A and 5B illustrate one path a tool may follow during a profiling operation;

FIGS. 6A and 6B illustrate a second path a tool may follow during a profiling operation; and

FIG. 7 illustrates a third path a tool may follow during a profiling operation.

### DESCRIPTION OF THE INVENTION

Overall, the method in accordance with the subject invention, is directed to controlled engagement of a plurality of cutting edges in a way resulting in a maximum cut chip thickness determined by the advance per tooth per revolution or the radial engagement of the milling tool or a combination of these conditions. Additionally, the method is directed to controlling the path of the tool relative to the work piece in such a way as to limit engagement and disengagement shock to the cutting edges while machining the work piece at elevated surface speeds available using current technology.

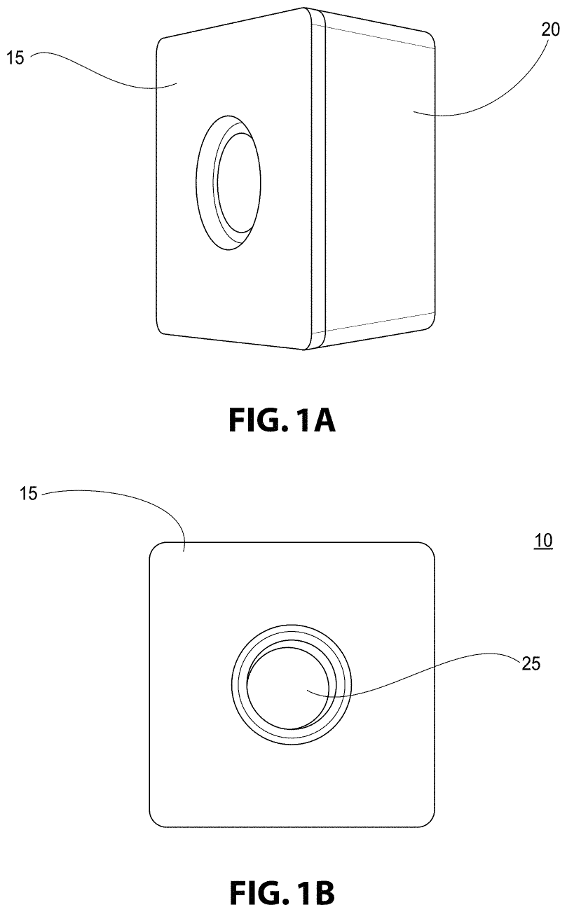

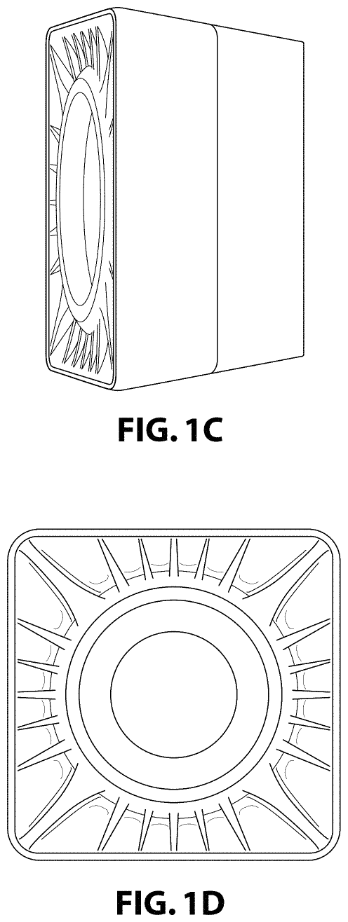

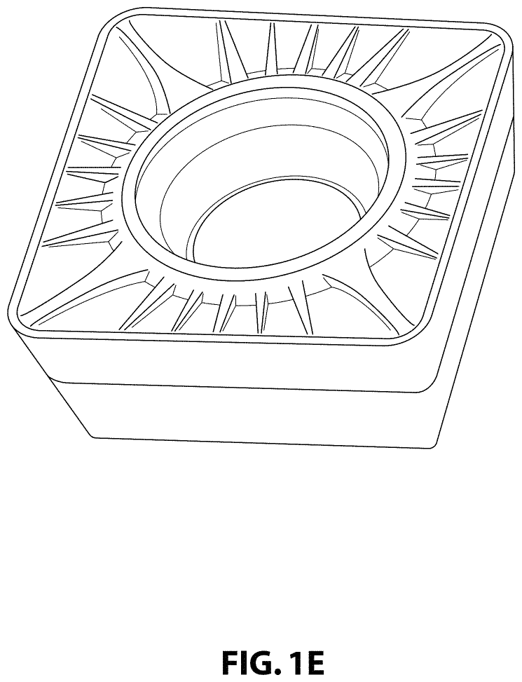

FIGS. 1A and 1B illustrate a cutting insert 10 with a PCD layer of material 15 integral to the substrate 20. As illustrated, the PCD material 15 extends over the entire top surface of the substrate 20. A central hole 25 extends through the insert 10 to accept a mounting screw for securing the cutting insert 10 to a tool holder. While the cutting insert 10 illustrated in FIGS. 1A and 1B has a hole to accept a mounting screw, it should be appreciated that the invention disclosed herein is applicable to any cutting tool that may be used to machine titanium including, but not limited to, completely solid cutting inserts (no through-hole) that may be secured using a clamp or to any other cutting tool that may be secured in another fashion.

While the cutting insert 10 illustrated in FIGS. 1A and 1B has a square shape when viewed from the top, the application of the PCD layer to the substrate as discussed herein is not limited to a square-shaped insert and may be applicable to inserts essentially of any shape. Furthermore, while illustrated in FIGS. 1A and 1B is a cutting insert 10 having the PCD material 15 extending over the entire top surface of the substrate 20, it is entirely possible for the PCD layer to be selectively applied to the portions of the substrate 20 on the insert adjacent to a cutting edge that will engage a work piece. Under these circumstances, it is preferred that the PCD material 15 extends in all cardinal directions beyond 1 millimeter within the region of the insert 10 that will engage the work piece. The PCD material 15 does not have to extend over the entire surface of the substrate 20 but should extend over no less than ⅓ of the top surface of the substrate 20.

FIGS. 1C-1E illustrate another embodiment in which the PCD layer includes ribs extending within a recessed portion in a generally radial direction from the center. These ribs provide structural support within the PCD layer and may also provide a region to provide enhanced chip breaking.

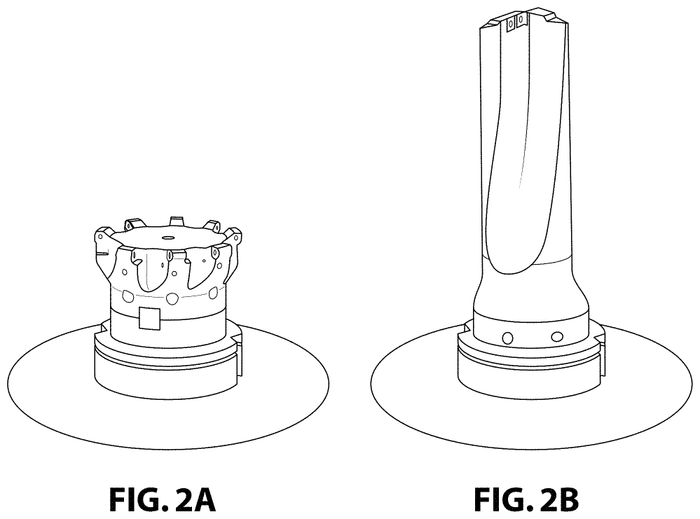

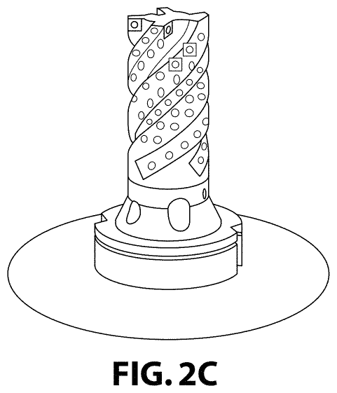

FIGS. 2A-2C show typical tool holders and, in particular, typical rotary tool holders that may be utilized to secure one or more of the cutting inserts 10 to engage in a machining operation. In particular, FIG. 2A illustrates a milling cutter, FIG. 2B illustrates a drill, and FIG. 2C illustrates an end mill. Each of these tool holders may be secured within a multi-axis CNC machine for a given machine operation.

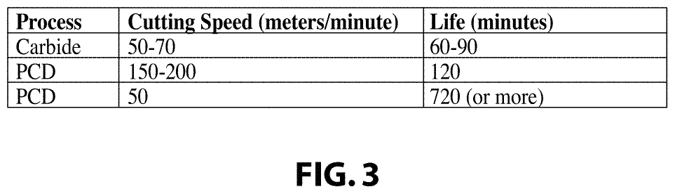

Directing attention to the table in FIG. 3, the Applicant has determined that by utilizing a PCD insert and the machining methods in accordance with the subject invention, it is possible to increase the cutting speed during a metal working operation up to five times that of a carbide tool's conventional speeds when applied to a workpiece made of titanium alloy such as, for example but not limited, to Ti-6AL4V. In particular, with reference to FIG. 3, a conventional cutting operation using a carbide insert may utilize cutting speeds between 50-70 meters per minute with a tool life of 60-90 minutes. On the other hand, utilizing a PCD insert in accordance with the subject invention, it is possible to maintain the cutting speed at the same speed of 50 meters per minute and the tool life will increase to over 720 minutes. To best utilize the subject invention, the Applicant believes that the high-speed application for the PCD insert is most optimum. In particular, under the proper conditions, in a preferred embodiment, the cutting speed for the PCD cutting insert may be 150-200 meters per minute and the tool life may be 90-120 minutes. As a result, not only does the PCD insert in accordance with the subject invention allow for high-speed machining, but when used appropriately, the tool life exceeds that of a carbide cutting insert counterpart.

Typical machining operations focus on the feed per tooth (also referred to as chip load) when machining a work piece and not on the maximum thickness of the cut chip. The Applicant has found that by focusing upon the maximum thickness of the cut chip, it is possible to optimize the machining operation for heat resistant super alloys such as titanium.

The PCD insert described herein is attractive because the relatively large volume of the PCD layer is able to absorb and transfer the heat. Heat transfer from the PCD layer may be assisted with coolant directed against the PCD layer. Additionally, PCD tends to be harder and, therefore, can resist abrasive wear longer than carbide so it doesn't physically wear away as fast as carbide, which is not as hard. Finally, PCD has a lower coefficient of friction compared to coated or uncoated cemented carbide with a higher coefficient. This lower coefficient of friction is significant for two reasons. It reduces the cutting friction and resulting heat generation and also reduces the amount of force required for the cutting insert to move through or along a work piece surface.

The thickness of the cutting chip is important. Determination of the cutting chip thickness is a function of the relationship between the tool diameter and the radial engagement amount and the feed rate per tooth per revolution. The diameter of the tool holder is given and the radial engagement and feed rate are specified in the programing of the machine tool for a tool path. As previously mentioned, unlike previous machining processes, the subject matter specifies the desired chip thickness as a limit and finds the given feed rate to use for a given radial engagement to assure the proper chip thickness. Conventional practice is to specify the radial engagement and the feed rate with the outcome being the resulting chip thickness.

What has so far been discussed, is the general application of machining heat resistant super alloys using PCD. There are particular applications to which this process is particularly beneficial.

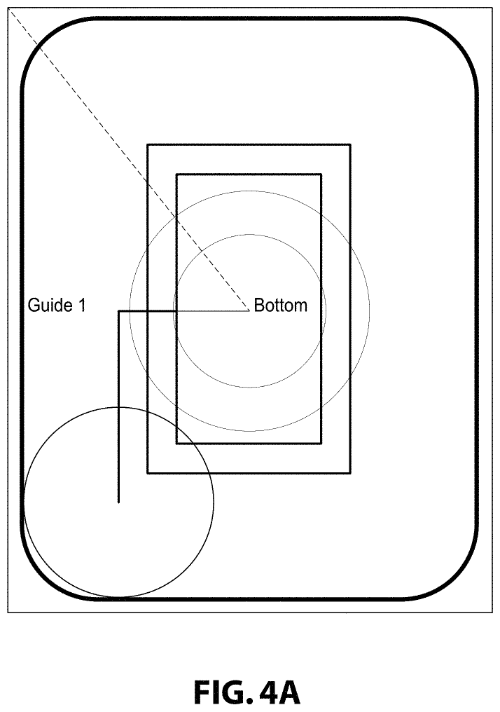

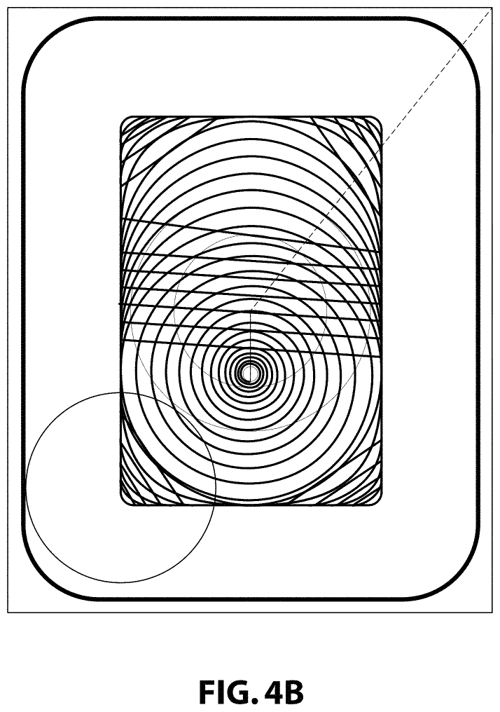

Pocket milling is a machining technique of removing the material within a closed boundary on a surface of a work piece to a particular depth. A prepared starter hole must be generated that is no less than 115% of the milling cutter diameter. In the past, as illustrated in FIG. 4A, the tool path would be multiple scaled down versions of the pocket profile geometry until the corner region was reached, at which time the cutting tool would machine the corners.

However, directing attention to FIG. 4B, a helical or at least spiral entry path may be utilized for entry into the side wall of the hole by the milling cutter until tangency is reached between the tool and the pocket wall and then the corners are machined following a constant radial engagement approach. Although the distance travelled by the cutting tool to achieve this spiral cutting may be greater, with the significantly increased cutting speed permitted through the use of PCD tools, the overall machining time is significantly reduced. Thereafter, once a significant portion of the material has been removed, then subsequent swaths of material may be removed by a radial path entry into the material such as in the Mastercam® dynamic milling path with a given step over an amount as a percentage of the cutter diameter. In this fashion, through the use of a milling cutter utilizing PCD inserts, the milling time may be significantly reduced. It should be appreciated that the feed rate per tooth per revolution previously discussed is applicable to this operation as well.

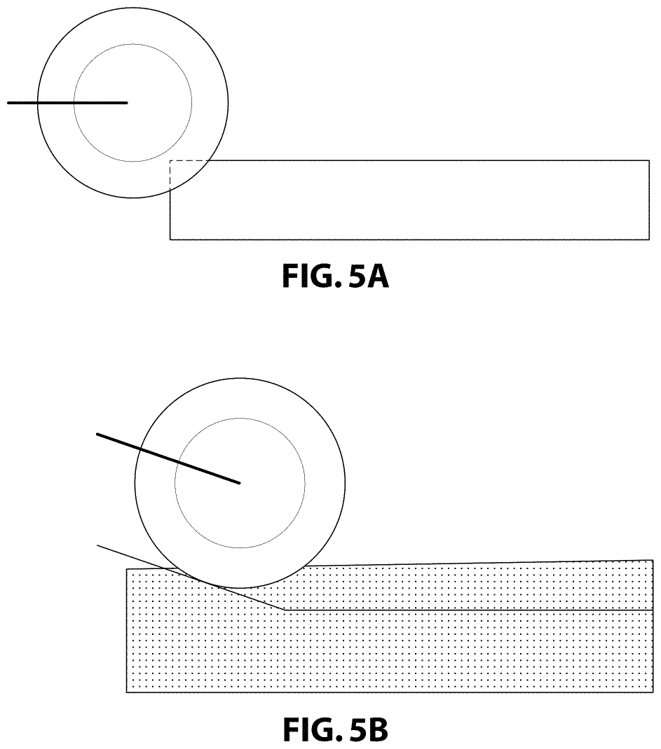

Profile milling is used to rough or finish mill vertical, slanted, or 5-axis ruled surfaces. The surfaces selected must allow for a continuous tool path. As illustrated in FIG. 5A, using conventional tooling, the depth of cut is fairly aggressive. As previously mentioned, utilizing carbide cutting inserts at the surface cutting speed may be between 50-70 meters per minute and the tool life may be 60-90 minutes. However, carbide inserts have a toughness significantly greater than PCD, and as a result, can tolerate the initial impact to the cutting inserts when the cutting edges first meet the shoulder of material to be profiled.

The inventors have discovered that through the use of PCD inserts, a profiling operation may be achieved in less time since the cutting speeds may now be up to 200 meters per minute. However, since the PCD insert is less tolerant to impact, the tool path for the profiling operation is different. There may be at least three options for profiling—an angled surface for a straight approach by the tool, part material prepared with a “ramp”, or a ramp shaped cutter path for a constant radial engagement and step over amount.

As a first example, as illustrated in FIG. 5B, for a profiling operation using PCD inserts, the cutting inserts are ramped in at 3.4-6.8 degrees with a radius of 60% of the cutter diameter into a straight portion of the profile cut. Thereafter, the cutter may return to the ramped portion and complete the machining operation. The length of the ramp could be between 2 times the diameter to 10 times the diameter. As an example, this would suggest a ramp between 160 millimeters to 800 millimeters ramp for an 80 millimeter diameter tool.

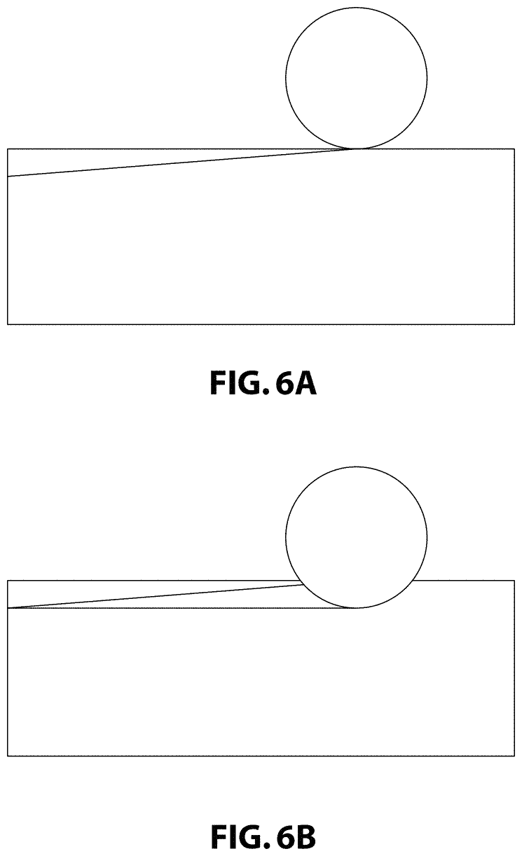

As a second example, the part material is prepared with a ramp. The ramp illustrated in FIG. 5B may be created using conventional techniques with tools more tolerant of impact in a fashion as shown in FIG. 6A. Thereafter, the PCD insert may be utilized to complete the profiling operation, as illustrated in FIG. 6B.

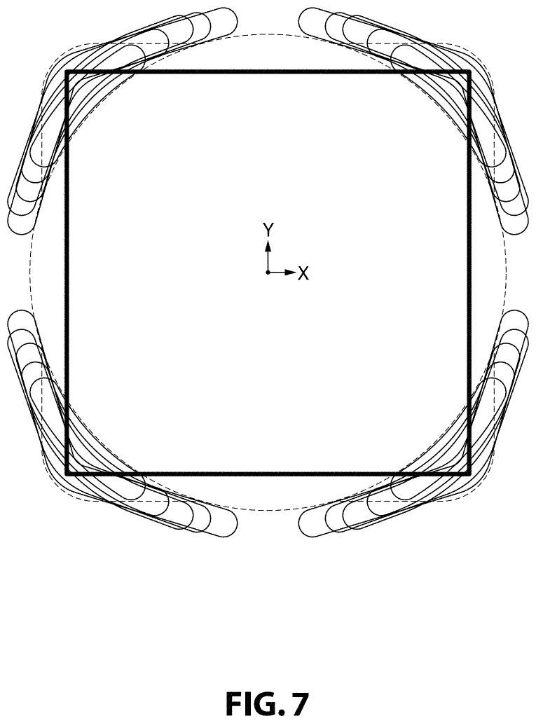

In yet another example of profiling, FIG. 7 illustrates an arrangement with the workpiece to be machined into a curved slope, such as a circle, using a constant radial engagement and step over amount. The tool path is shown with lines around the workpiece. To provide constant radial engagement, the tool path engages a small portion of the corner to minimize impact upon the insert and then the tool begins a curved path. Through multiple interactions, a curved shape is imparted to the entire workpiece with constant radial engagements.

The key is that these tool paths control the change in radial engagement so that the increase in load on the tool is very smooth and gradual. Most importantly, there is no abrupt change in direction of the tool. By doing so, a profiling operation utilizing PCD inserts will take less time and with greater tool life for efficiency not previously achieved using conventional carbide tooling.

Aside from milling, the inventors have also discovered that PCD inserts may be useful while machining heat resistant super alloys during a drilling operation using, for example, the tool holder which is a drill illustrated in FIG. 2B. Just as before, a surface speed of between 50-200 meters per minute is utilized and a feed rate of between 0.050 to 0.200 millimeters per revolution could be implemented. Once again, it is necessary to control increased feed rate over a given distance of entry, and to achieve such a goal, for example, the G93.2 Fanuc rate feed option (A02B-0326-R635) may be utilized. However, it is possible to generate new or to use existing machine algorithms to achieve this task. Such technology is known to those skilled in the art.

What has so far been described are metal working operations directed to milling and drilling. However, it should be appreciated that the concepts applied herein may be equally applied to other machining operations, such as boring with similar benefits.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the example(s) as oriented in the drawing figures. However, it is to be understood that the example(s) may assume various alternative variations and step sequences, except where expressly specified to the contrary. It is also to be understood that the specific example(s) illustrated in the attached drawings, and described in the following specification, are simply exemplary examples or aspects of the invention. Hence, the specific examples or aspects disclosed herein are not to be construed as limiting.

Although the invention has been described in some detail for the purpose of illustration based on what is currently considered to be the most practical preferred and non-limiting embodiments, examples, or aspects, it is to be understood that such detail is solely for that purpose and that the invention is not limited to the disclosed preferred and non-limiting embodiments, examples, or aspects, but, on the contrary, is intended to cover modifications and equivalent arrangements that are within the spirit and scope of the appended claims. For example, it is to be understood that the present invention contemplates that, to the extent possible, one or more features of any preferred and non-limiting embodiment, example, or aspect can be combined with one or more features of any other preferred and non-limiting embodiment, example, or aspect.

The invention claimed is:

1. Using at least one cutting insert mounted upon a rotary toolholder, wherein the at least one cutting insert is comprised of a substrate having a top layer of PCD secured thereto over no less than ⅓ of a substrate top surface, a method of machining heat resistant super alloys (HRSAs) comprising the steps of:
a) rotating the rotary toolholder such that an insert surface speed rate is above 50 meters per minute; and
b) adjusting a tool feed rate (advance per tooth per revolution) and/or radial engagement of the toolholder such that the machining operation produces chips having a thickness of approximately 0.050-0.200 millimeters.

2. The method according to claim 1, wherein the HRSA material is a titanium alloy.

3. The method according to claim 1, wherein the HRSA material is Ti-6AL4V.

4. The method according to claim 1, wherein the PCD material extends over the entire top surface of the substrate.

5. The method according to claim 1, wherein the PCD material extends over no less than ⅓ of the top surface of the substrate in the region of contact and the PCD extends over 1 millimeter in each cardinal direction.

6. The method according to claim 1, further including the step of directing a flow of coolant primarily over the top surface of the PCD.

7. The method according to claim 1, wherein the run out from the centerline of the toolholder and the edge of each of the at least one cutting insert is no more than 0.030 millimeter.

8. The method according to claim 1, wherein the method of machining applies to a milling operation.

9. The method according to claim 8, wherein the milling operation is pocketing.

10. The method according to claim 9, wherein a tool path for the pocketing operation is selected to maximize the opportunity for high-speed machining.

11. The method according to claim 10, wherein the pocketing operation is comprised of the following steps:
a) generate a hole in a workpiece that is larger than the milling tool diameter;
b) perform a continuous operation requiring minimum feed rate fluctuation, such as spiraling, for a majority of the machining; and
c) perform the remainder of the machining utilizing conventional techniques based upon pre-defined standard tool paths.

12. The method according to claim 8, wherein a milling operation is profiling.

13. The method according to claim 12, wherein the at least one cutting insert is introduced to the workpiece along a shallow ramp to allow maximum surface speed and maximum tool life of the at least one cutting insert.

14. The method according to claim 12, wherein the at least one cutting insert is introduced along a shallow ramp created using conventional tools.

15. The method according to claim 12, wherein the at least one cutting insert utilizes a constant radial engagement and step over amount.

16. The method according to claim 1, wherein the method of machining applies to a drilling operation.

17. The method according to claim 16, wherein the feed rate for the drill is between 0.100-0.200 millimeter per revolution.
